(19) United States
(12) Patent Application Publication
(10) Pub. No.: US 2019/0072058 A1
(43) Pub. Date: Mar. 7, 2019

(54) AIR CLEANER CASE

(71) Applicant: TOYOTA BOSHOKU KABUSHIKI KAISHA, Aichi-ken (JP)

(72) Inventors: Kenta KUMAZAWA, Aichi-ken (JP); Yasushi NARITA, Aichi-ken (JP); Eita KATO, Aichi-ken (JP); Kenji IKEDA, Aichi-ken (JP); Takao ISHIKAWA, Aichi-ken (JP); Shota YAMADA, Aichi-ken (JP)

(73) Assignee: TOYOTA BOSHOKU KABUSHIKI KAISHA, Aichi-ken (JP)

(21) Appl. No.: 16/105,624

(22) Filed: Aug. 20, 2018

(30) Foreign Application Priority Data
Sep. 4, 2017 (JP) 2017-169836

(51) Int. Cl. F02M 35/08; B01D 46/48; B01D 46/42

(52) U.S. Cl. CPC F02M 35/088; B01D 46/48; B01D 2279/60; F02M 35/084; B01D 46/4272

(57) ABSTRACT

The air cleaner case includes a valve structure capable of opening and closing a dust discharge port. The valve structure includes: a float member which is disposed below the dust discharge port and can float on water due to its buoyancy; a guide member which holds the float member in a state of being spaced downward from the dust discharge port and, at the time of water immersion, guides the float member ascending due to its buoyancy together with the water level toward the dust discharge port; and a valve body which is spaced downward from the dust discharge port together with the float member to open the dust discharge port and, upon ascent of the float member, comes into contact with the outer circumferential side of the dust discharge port of the bottom wall to close the dust discharge port.

### INCORPORATION BY REFERENCE

The present application claims priority under 35 U.S.C. § 119 of Japanese Application No. 2017-169836 filed on Sep. 4, 2017, the disclosure of which is expressly incorporated by reference herein in its entirety.

### BACKGROUND

### 1. Technical Field

The present invention relates to an air cleaner case, and more particularly, to an air cleaner case having a dust discharge port provided in a bottom wall thereof.

### 2. Related Art

As conventional air cleaner cases, those having a dust discharge port provided in a bottom wall thereof are generally known (for example, see Japanese Patent Application Laid-Open No. 2015-068200 and Japanese Patent Application Laid-Open No. 2015-175242). In an air cleaner case of this type, a valve structure 111 having an elastic valve 110 attached to a bottom wall 105 of a case 101 to open and close a dust discharge port 107 is provided, for example, as shown in FIG. 9. In the valve structure 111, when the amount of dust d such as sand accumulated in the case 101 is small at a normal time (for example, at the time of non-water immersion, weak water immersion, or the like), the elastic valve 110 comes into contact with the bottom wall 105 to close the dust discharge port 107 (see FIG. 9A). When the amount of the dust d accumulated in the case 101 increases, the elastic valve 110 is deformed by the weight of the dust d, thereby opening the dust discharge port 107 to discharge the dust d (see FIG. 9B). On the other hand, at the time of water immersion, the elastic valve 110 is pressed against the bottom wall 105 by water pressure, thereby closing the dust discharge port 107 to prevent water from entering the case 101 (see FIG. 9C).

However, in the conventional valve structure 111, the elastic valve 110 attached to the bottom wall 105 of the case 101 is adopted. Thus, depending on how the dust d is accumulated in the case 101, the elastic valve 110 is not deformed because the weight of the dust d is too light, so that the dust d is hardly discharged. Furthermore, at a normal time, the elastic valve 110 is deformed by vibration, so that the dust d is easily discharged though in a very small amount. But, when muddy dust is accumulated, the dust discharge port 107 can be clogged.

Note that Japanese Patent Application Laid-Open No. 2015-068200 discloses a technique of providing a drain hole in a bottom wall of a case and also providing a valve structure for preventing water from entering the case at the time of flooding in an air introduction passage connected to the case, in an air cleaner device. However, the technique disclosed in Japanese Patent Application Laid-Open No. 2015-068200 is not intended to close the drain hole, so that it is impossible to completely prevent water from entering the case. Furthermore, the mechanism such as a valve body and an arm which constitute the valve structure becomes complicated, the number of parts is large, and thus the reduction in productivity and the increase in costs are concerned. In addition, Japanese Patent Application Laid-Open No. 2015-175242 describes a technique of providing a dust discharge valve formed of an elastic material on a bottom wall of a case in an air cleaner, but does not clearly describe water entering the case at the time of water immersion, and there is concern that water may enter from a gap formed in a lip part of the dust discharge valve.

### SUMMARY

An embodiment of the present invention has been made in view of the above-described circumstances, and an object thereof is to provide an air cleaner case capable of compatibly achieving both of a function of discharging dust out of a case and a function of shutting off water entry into the case.

One aspect of the present embodiments provides an air cleaner case having a dust discharge port provided in a bottom wall of the air cleaner case, the air cleaner case comprising a valve structure capable of opening and closing the dust discharge port, wherein the valve structure comprises: a float member which is disposed below the dust discharge port and can float on water due to buoyancy; a guide member which holds the float member in a state of being spaced downward from the dust discharge port and, at the time of water immersion, guides the float member ascending due to buoyancy together with the water level toward the dust discharge port; and a valve body which is spaced downward from the dust discharge port together with the float member to open the dust discharge port and, upon ascent of the float member, comes into contact with an outer circumferential side of the dust discharge port of the bottom wall to close the dust discharge port.

In a further aspect, the valve body may be composed of the float member capable of coming into contact with the outer circumferential side of the dust discharge port of the bottom wall.

In a further aspect, an opening area of the dust discharge port may be smaller than an area surrounded by a line of contact with the water surface of the float member floating on water.

In a further aspect, the opening of the dust discharge port may be formed in a planar circular shape, and wherein the float member may be formed in a spherical shape.

In a further aspect, at least one of the outer circumferential side of the dust discharge port of the bottom wall and the float member may be formed of an elastic material.

In a further aspect, the float member may be formed of an elastic material and formed in a solid or hollow spherical shape.

In a further aspect, an annular gasket may be attached to a through hole formed in the bottom wall, the annular gasket being formed of an elastic material and having an inner circumferential side which constitutes the dust discharge port, and wherein the float member may come into contact with the annular gasket to close the dust discharge port.

In a further aspect, a tapered surface whose diameter reduces upward toward the opening of the dust discharge port may be formed on the outer circumferential side of the dust discharge port of the bottom wall.

In a further aspect, the guide member may comprise a tubular guide wall extending downward from the bottom wall so as to surround the float member and a holding part provided on the bottom side of the guide wall, and wherein the holding part may be formed so as to permit passage of dust and to allow the float member to be mounted and held.

In a further aspect, the valve body may be attached to an upper part of the float member.

In a further aspect, the valve body may be provided to be capable of ascending and descending between the float member and the bottom wall and capable of being pushed up by the float member ascending at the time of water immersion.

An air cleaner case of the present embodiment is provided with a valve structure capable of opening and closing a dust discharge port. The valve structure includes: a float member which is disposed below the dust discharge port and can float on water due to its buoyancy; a guide member which holds the float member in a state of being spaced downward from the dust discharge port and, at the time of water immersion, guides the float member ascending due to its buoyancy together with the water level toward the dust discharge port; and a valve body which is spaced downward from the dust discharge port together with the float member to open the dust discharge port and, upon ascent of the float member, comes into contact with the outer circumferential side of the dust discharge port of the bottom wall to close the dust discharge port. Thus, at a normal time, the float member is held, by the guide member, in a state of being spaced apart downward from the dust discharge port by gravity, so that the valve body is spaced apart from the dust discharge port to widely open the dust discharge port. So, dust such as sand collected within the case is smoothly discharged. Especially, the dust discharge port is hardly clogged even with muddy dust. On the other hand, at the time of water immersion, the float member ascending together with the water level due to its buoyancy is guided toward the dust discharge port by the guide member, whereby the valve body comes into contact with the outer circumferential side of the dust discharge port of the bottom wall to close the dust discharge port, so that the entry of water into the case is effectively suppressed.

When the valve body is composed of the float member capable of coming into contact with the outer circumferential side of the dust discharge port of the bottom wall, an upper part of the float member is placed inside the dust discharge port in a state where the float member comes into contact with the outer circumferential side of the dust discharge port of the bottom wall to close the dust discharge port. Thus, the sealability of the dust discharge port is maintained even if lateral vibration occurs on the water surface. Further, the valve body is constituted using the float member, thereby making it possible to reduce the number of parts and to realize a simple and inexpensive structure.

When an opening area of the dust discharge port is smaller than an area surrounded by a line of contact with the water surface of the float member floating on water, the dust discharge port is closed by the float member before the water level at the time of water immersion reaches the dust discharge port.

In addition, the opening of the dust discharge port is formed in a planar circular shape, and when the float member is formed in a spherical shape, the sealability of the dust discharge port by the float member is enhanced.

In addition, when at least one of the outer circumferential side of the dust discharge port of the bottom wall and the float member is formed of an elastic material, the sealability of the opening of the dust discharge port by the float member is enhanced.

In addition, when the float member is formed of an elastic material and formed in a solid or hollow spherical shape, the sealability of the opening of the dust discharge port by the float member is enhanced.

Further, when an annular gasket is attached to a through hole formed in the bottom wall, and the float member comes into contact with the annular gasket to close the dust discharge port, the sealability of the opening of the dust discharge port by the float member is enhanced.

When a tapered surface is formed on the outer circumferential side of the dust discharge port of the bottom wall, the float member is stably brought into contact with the outer circumferential side of the dust discharge port of the bottom wall by the tapered surface.

Further, when the guide member includes a guide wall and a holding part, and the holding part is formed so as to allow passage of dust and to allow the float member to be mounted and held, the guide wall can smoothly guide the float member toward the dust discharge port while restricting the lateral movement of the float member and can reduce the transfer of the lateral vibration applied to the water surface to the float member. Furthermore, the float member can be stably mounted and held by the holding part, and dust can be discharged smoothly.

Further, when the valve body is attached to an upper part of the float member, the dust discharge port is opened and closed by the ascending and descending operation of the valve body integrated with the float member.

Further, when the valve body is provided so that it can ascend and descend between the float member and the bottom wall and can be pushed up by the float member ascending at the time of water immersion, the valve body is positioned at a descending end upon descent of the float member to open the dust discharge port while the valve body is pushed up by the ascent of the float member to close the dust discharge port.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a vertical sectional view schematically showing an air cleaner case according to Example 1.

FIGS. 2A and 2B are a longitudinal sectional view of a valve structure according to Example 1, in which FIG. 2A shows a state in which dust is discharged from the inside of the case at a normal time and FIG. 2B shows a state in which water is prevented from entering the case at the time of water immersion.

FIG. 3 is an explanatory diagram for explaining a dust discharge port according to Example 1.

FIG. 4A to 4C are an explanatory view for explaining a float member according to another form, in which FIG. 4A shows a hollow float member, FIG. 4B shows an ellipsoidal float member, and FIG. 4C shows a conical float member.

FIGS. 5A and 5B are a longitudinal sectional view of a valve structure according to Example 2, in which FIG. 5A shows a state in which dust is discharged from the inside of a case at a normal time and FIG. 5B shows a state in which water is prevented from entering the case at the time of water immersion.

FIGS. 6A and 6B are a longitudinal sectional view of a valve structure according to Example 3, in which FIG. 6A shows a state in which dust is discharged from the inside of a case at a normal time and FIG. 6B shows a state in which water is prevented from entering the case at the time of water immersion.

FIGS. 7A and 7B are a longitudinal sectional view of a valve structure according to Example 4, in which FIG. 7A shows a state in which dust is discharged from the inside of a case at a normal time and FIG. 7B shows a state in which water is prevented from entering the case at the time of water immersion.

FIGS. 8A and 8B are a vertical sectional view of a valve structure according to another form, wherein FIG. 8A shows a state in which dust is discharged from the inside of a case at a normal time and FIG. 8B shows a state in which water is prevented from entering the case at the time of water immersion.

FIG. 9A to 9C are a vertical sectional view of a conventional valve structure, in which FIG. 9A shows a state in which dust is gradually accumulated in a case at a normal time, FIG. 9B shows a state in which dust is discharged from the inside of the case at a normal time, and FIG. 9C shows a state in which water is prevented from entering the case at the time of water immersion.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

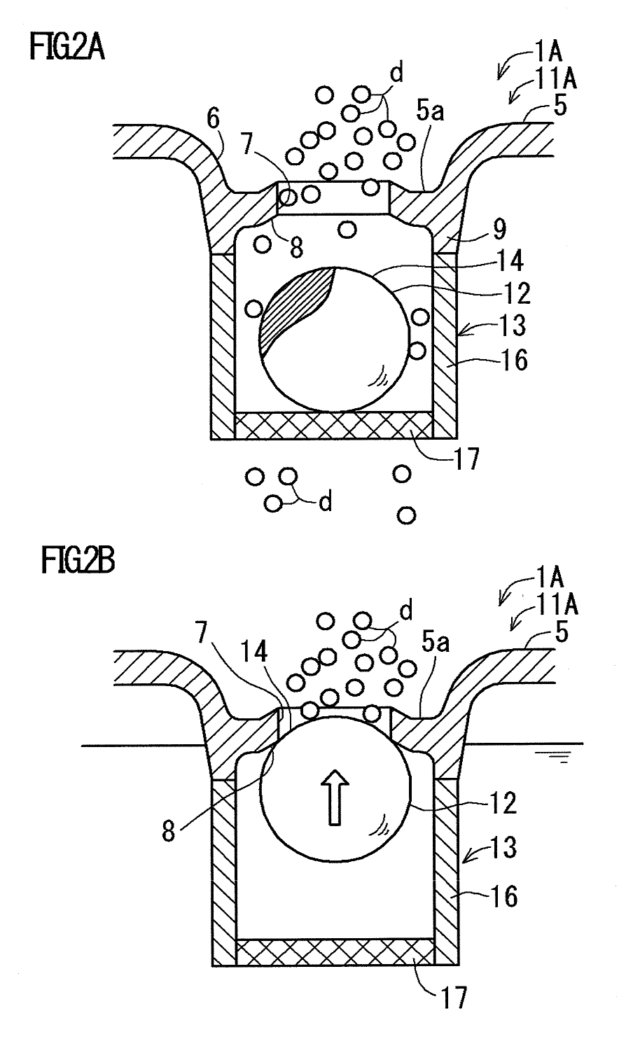

An air cleaner case according to the present embodiment is an air cleaner case (1A to 1D) having a dust discharge port (7) provided in a bottom wall (5a), the air cleaner case including a valve structure (11A to 11D) capable of opening and closing the dust discharge port, wherein the valve structure includes: a float member (12, 12a to 12c) which is disposed below the dust discharge port and can float on water due to its buoyancy; a guide member (13, 37) which holds the float member in a state of being spaced downward from the dust discharge port and, at the time of water immersion, guides the float member ascending due to its buoyancy together with the water level toward the dust discharge port; and a valve body (14, 32, 42) which is spaced downward from the dust discharge port to open the dust discharge port and, upon ascent of the float member, comes into contact with the outer circumferential side of the dust discharge port (7) of the bottom wall (5a) to close the dust discharge port (for example, see FIGS. 2 and 5 to 8). The shapes, materials, sizes, and the like of the float member, guide member, and valve body are not particularly limited.

As the air cleaner case according to the present embodiment, for example, there is indicated a form in which the valve body (14) is composed of a float member (12, 12a to 12c) capable of coming into contact with the outer circumferential side of the dust discharge port (7) of the bottom wall (5a) (for example, see FIGS. 2 and 5.).

In the case of the above-described form, for example, an opening area (S1) of the dust discharge port (7) can be smaller than an area (S2) surrounded by a line of contact with the water surface of the float member (12, 12a to 12c) floating on water (for example, see FIG. 3). A ratio (S1/S2) between the opening area (S1) of the dust discharge port and the area (S2) surrounded by the line of contact with the water surface of the float member is, for example, 0.1 to 0.5 (preferably 0.2 to 0.4). Furthermore, in the case of the above-described form, for example, the opening of the dust discharge port (7) can be formed in a planar circular shape, and the float member (12) can be formed in a spherical shape.

In the above-described form, for example, at least one of the outer circumferential side of the dust discharge port (7) of the bottom wall (5a) and the float member (12, 12a to 12c) can be formed of an elastic material (for example, see FIGS. 2 and 5). Examples of the elastic material include rubber and thermoplastic elastomers.

In the case of the above-described form, for example, a tapered surface (8, 24) whose diameter reduces upward toward the opening of the dust discharge port can be formed on the outer circumferential side of the dust discharge port (7) of the bottom wall (5a) (for example, see FIGS. 2 and 5). Thus, the float member is stably brought into contact with the outer circumferential side of the dust discharge port of the bottom wall by the tapered surface.

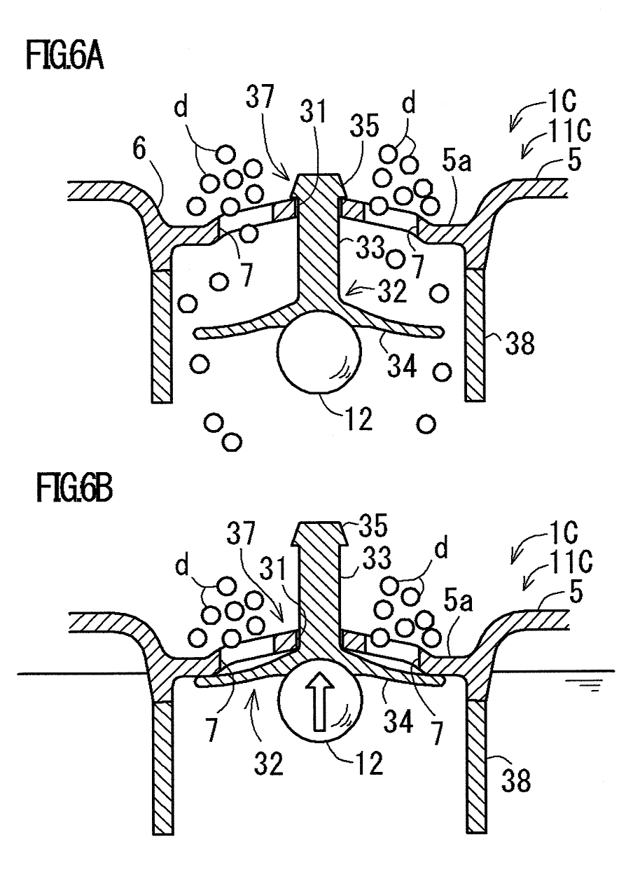

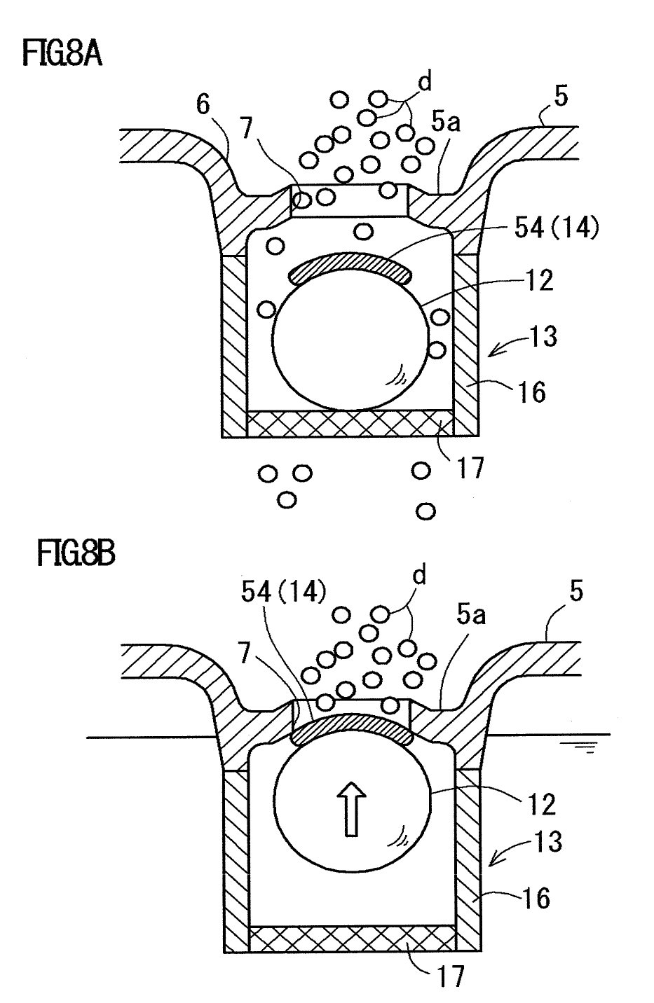

As the air cleaner case according to the present embodiment, for example, there is indicated a form in which the valve body (32, 54) is attached to an upper part of the float member (12, 12a to 12c) (see, for example, FIGS. 6 and 8). In this case, for example, the valve body (32) includes: a shaft part (33) which is vertically movably supported by a support hole (31) formed in the bottom wall (5a); and an umbrella-shaped part (34) which is connected to the lower end side of the shaft part and whose circumferential part comes into contact with the outer circumferential side of the dust discharge port (7) of the bottom wall (5a) to cover and close the dust discharge port formed on the outer circumferential side of the support hole. The float member (12) can be integrally provided on the bottom surface side of the umbrella-shaped part (see, for example, FIG. 6).

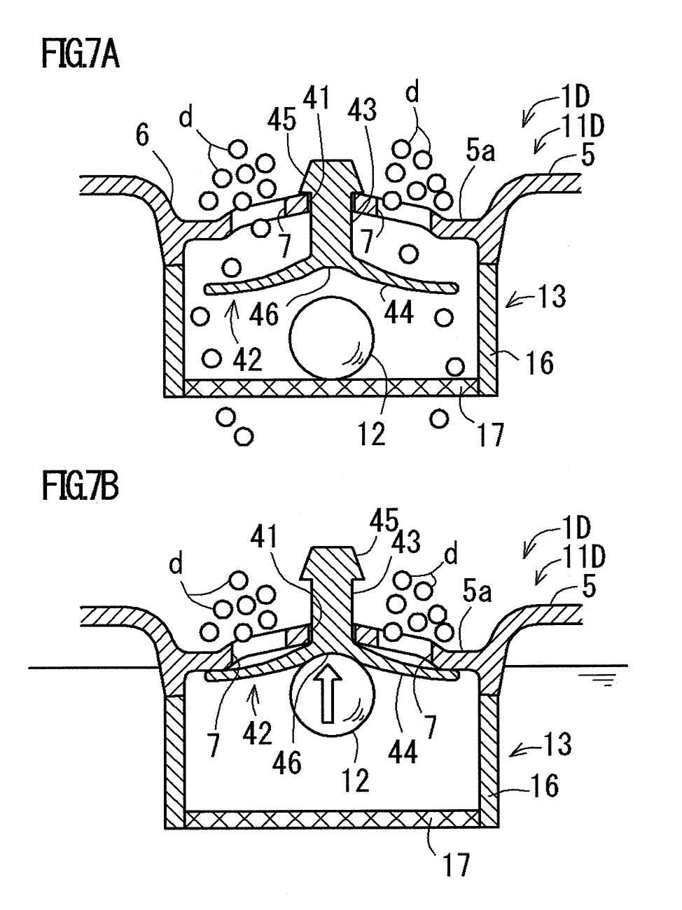

As the air cleaner case according to the present embodiment, for example, there is indicated a form in which the valve body (42) is provided so that it can ascend and descend between the float member (12, 12a to 12c) and the bottom wall (5a) and, at the time of water immersion, can be pushed up by the float member (for example, see FIG. 7). In this case, for example, the valve body (42) includes: a shaft part (43) which is vertically movably supported by a support hole (41) formed in the bottom wall (5a); and an umbrella-shaped part (44) which is connected to the lower end side of the shaft part and whose circumferential part comes into contact with the outer circumferential side of the dust discharge port (7) of the bottom wall (5a) to cover and close the dust discharge port formed on the outer circumferential side of the support hole. A pushed-up part (46) which can be pushed up by the float member ascending at the time of water immersion can be provided on the bottom surface side of the umbrella-shaped part.

As the air cleaner case according to the present embodiment, for example, there is indicated a form in which the guide member (14) includes a tubular guide wall (16) extending downward from the bottom wall (5a) so as to surround the float member (12, 12a to 12c) and a holding part (17) provided on the bottom side of the guide wall, and the holding part is formed so as to allow passage of dust (d) and to allow the float member to be mounted and held (for example, see FIG. 2). As a result, the guide wall can smoothly guide the float member toward the dust discharge port while restricting the lateral movement of the float member and can reduce the transfer of the lateral vibration applied to the water surface to the float member. Furthermore, the float member can be stably mounted and held by the holding part, and dust can be discharged smoothly.

Note that reference numerals in parentheses attached to the respective components described in the above embodiments indicate correspondence relationships with specific components referred to in the Examples which will be described later.

### EXAMPLES

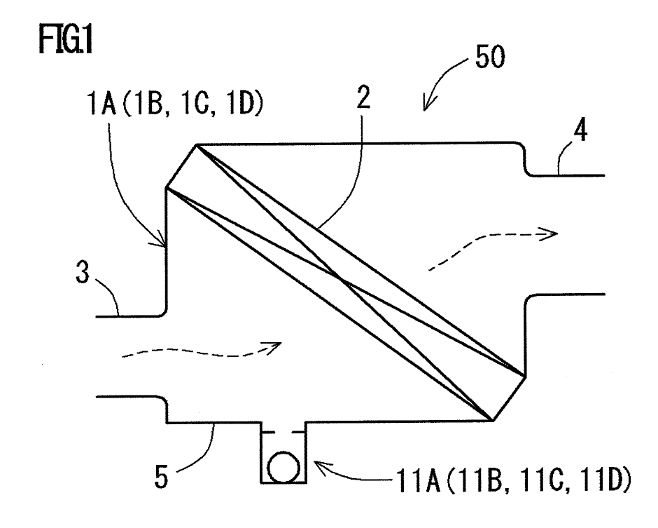

Hereinafter, the present invention will be described in detail with reference to the accompanying drawings. In the Examples, air cleaner cases 1A, 1B, 1C and 1D, each of which constitutes an air cleaner device 50 provided in an intake passage of an internal combustion engine, are exemplified as the air cleaner case according to the present invention (see FIG. 1).

### Example 1

### (1) Configuration of Air Cleaner Case

As shown in FIG. 1, the air cleaner case (hereinafter, also referred to simply as “case”) 1A according to the present Example is formed of a synthetic resin material, and is provided with a filter element 2 which partitions the inside of the case into the upstream side and the downstream side. To a side wall of the case 1A, an inlet tube 3 is connected so as to be connected to the upstream side of the filter element 2 and an outlet tube 4 is connected to the downstream side of the filter element 2. In an engine room mounted with the air cleaner device 50, it is assumed that the bottom side of the case 1A is immersed in water due to running on a waterway, heavy rain, or the like.

As shown in FIGS. 2 and 3, a bottom wall 5 of the case 1A is formed with a concave part 6 extending downward. In a bottom wall 5a of the concave part 6, there is formed a dust discharge port 7 for discharging dust d such as sand collected and accumulated in the case 1A. This dust discharge port 7 constitutes a communication hole for communicating the inside and outside of the case 1A. An opening area S1 of the dust discharge port 7 is set to a value smaller than an area S2 surrounded by a line of contact with the water surface of a float member 12, as will be described later, which floats on water. A ratio between the opening area SI of the dust discharge port 7 and the area S2 surrounded by the line of contact with the water surface of the float member 12 is set to about 0.3. Further, the opening of the dust discharge port 7 is formed in a planar circular shape. Further, a tapered surface 8 whose diameter reduces upward toward the opening of the dust discharge port 7 is formed on the outer circumferential side of the dust discharge port 7 of the bottom wall 5a (specifically, the peripheral part of the dust discharge port 7 on the bottom surface side of the bottom wall 5a). Further, a tubular part 9 extending downward is formed on the outer circumferential part of the bottom wall 5a. The case 1A is provided with a valve structure 11A which is disposed on the bottom side of the bottom wall 5a and opens and closes the dust discharge port 7.

As shown in FIG. 2, the valve structure 11A includes: a float member 12 which is disposed below the dust discharge port 7 and can float on water due to its buoyancy; a guide member 13 which holds the float member 12 in a state of being spaced downward from the dust discharge port 7 and, at the time of immersion, guides the float member 12 ascending due to its buoyancy together with the water level toward the dust discharge port 7; and a valve body 14 which is spaced downward from the dust discharge port 7 together with the float member 12 to open the dust discharge port 7 and, upon ascent of the float member 12, comes into contact with the outer circumferential side of the dust discharge port 7 of the bottom wall 5a (specifically, the peripheral part of the dust discharge port 7 on the bottom surface side of the bottom wall 5a) to close the dust discharge port 7. The valve body 14 is composed of the float member 12 that can come into contact with the outer circumferential side of the dust discharge port 7 of the bottom wall 5a (specifically, a part above the water surface of the float member 12 floating on water).

The float member 12 is formed of an elastic material such as rubber into a solid spherical shape. This float member 12 can float on water due to the action of upward resultant force (F1−F2) as a difference between buoyancy F1 and gravity F2 (see FIG. 3). Note that the buoyancy F1 is represented by V·ρw·g and the gravity F2 is represented by V·ρ·g (V: volume [m³] of the float member, ρ: density [kg/m³] of the float member, ρw: density [kg/m³] of water, g: gravitational acceleration [m/s²]).

The guide member 13 includes a cylindrical guide wall 16 extending downward from the bottom wall 5a so as to surround the float member 12 and a disk-shaped holding part 17 provided on the bottom side of the guide wall 16. The guide wall 16 has an inner diameter slightly larger than the outer diameter of the float member 12, and, at the time of water immersion, guides the float member 12 toward the dust discharge port 7 while restricting the lateral movement of the float member 12. The upper end side of the guide wall 16 is joined to the lower end side of the tubular part 9 by adhesion, welding, or the like. Further, the holding part 17 is formed in a shape (for example, a net shape, a fence shape, or the like) allowing passage of the dust d and allowing the float member 12 to be mounted and held while restricting passage of the float member 12.

### (2) Action of Air Cleaner Case

Next, the action of the air cleaner case 1A having the above configuration will be described. As shown in FIG. 2A, at a normal time (that is, at a non-buoyancy application time when no buoyancy is applied to the float member 12, for example, at the time of non-water immersion or weak water immersion), the float member 12 is held, by the guide member 13, in a state of being spaced apart downward from the dust discharge port 7 by gravity. In this state, the float member 12 is spaced apart from the dust discharge port 7 to open the dust discharge port 7, whereby the dust d such as sand collected in the case 1A is discharged. On the other hand, as shown in FIG. 2B, at the time of water immersion (that is, at a buoyancy application time when buoyancy is applied to the float member 12), the float member 12 ascending together with the water level due to its buoyancy is guided toward the dust discharge port 7 by the guide member 13. At this time, the float member 12 comes into contact with the outer circumferential side of the dust discharge port 7 of the bottom wall 5a to close the dust discharge port 7, whereby the entry of water into the case 1A is suppressed.

### (3) Effect of Example

The air cleaner case 1A of the present Example is provided with the valve structure 11A capable of opening and closing the dust discharge port 7, and the valve structure 11A includes the float member 12 which is disposed below the dust discharge port 7 and can float on water due to its buoyancy; the guide member 13 which holds the float member 12 in a state of being spaced downward from the dust discharge port 7 and, at the time of water immersion, guides the float member 12 ascending due to its buoyancy together with the water level towards the dust discharge port 7; and the valve body 14 which is spaced downward from the dust discharge port 7 together with the float member 12 to open the dust discharge port 7 and, upon ascent of the float member 12, comes into contact with the outer circumferential side of the dust discharge port 7 of the bottom wall 5a to close the dust discharge port 7. Thus, at a normal time, the float member 12 is held, by the guide member 13, in a state of being spaced apart downward from the dust discharge port 7 by gravity, so that the valve element 14 is spaced apart from the dust discharge port 7 to widely open the dust discharge port 7 so that the dust d such as sand collected in the case 1A is smoothly discharged. Especially, the dust discharge port 7 is hardly clogged even with muddy dust d. On the other hand, at the time of water immersion, the float member 12 ascending together with the water level due to its buoyancy is guided toward the dust discharge port 7 by the guide member 13, whereby the valve body 14 comes into contact with the outer circumferential side of the dust discharge port 7 of the bottom wall 5a to close the dust discharge port 7, so that the entry of water into the case 1A is effectively suppressed.

Further, in the present Example, the valve body 14 is composed of the float member 12 which can come into contact with the outer circumferential side of the dust discharge port 7 of the bottom wall 5a. Thus, since an upper part of the float member 12 is placed inside the dust discharge port 7 in a state where the dust discharge port 7 is closed by the float member 12, even if lateral vibration occurs on the water surface, the sealability of the dust discharge port 7 is maintained. Further, the valve body 14 is constituted using the float member 12, thereby making it possible to reduce the number of parts and to realize a simple and inexpensive structure.

Further, in the present Example, the opening area Si of the dust discharge port 7 is smaller than the area S2 surrounded by the line of contact with the water surface of the float member 12 floating on water. As a result, the dust discharge port 7 is closed by the float member 12 before the water level at the time of water immersion reaches the dust discharge port 7.

Further, in the present Example, the opening of the dust discharge port 7 is formed in a planar circular shape, and the float member 12 is formed in a spherical shape. Thus, the sealability of the dust discharge port 7 by the float member 12 is enhanced. Further, in the present Example, the float member 12 is formed of an elastic material. Thus, the sealability of the dust discharge port 7 by the float member 12 is enhanced.

Further, in the present Example, the tapered surface 8 whose diameter reduces upward toward the opening of the dust discharge port 7 is formed on the outer circumferential side of the dust discharge port 7 of the bottom wall 5a. As a result, the float member 12 is stably brought into contact with the outer circumferential side of the dust discharge port 7 of the bottom wall 5a by the tapered surface 8.

Furthermore, in the present Example, the guide member 13 includes the tubular guide wall 16 extending downward from the bottom wall 5a so as to surround the float member 12 and a holding part 17 provided on the bottom side of the guide wall 16, and the holding part 17 is formed so as to allow the passage of the dust d and to allow the float member 12 to be mounted and held. Thus, the guide wall 16 can smoothly guide the float member 12 toward the dust discharge port 7 while restricting the lateral movement of the float member 12 and can reduce the transfer of the lateral vibration applied to the water surface to the float member 12. Furthermore, the holding part 17 allows the float member 12 to be stably mounted and held and also allows the dust d to be discharged smoothly.

### Example 2

Next, an air cleaner case 1B according to Example 2 will be described. The same reference numerals are given to substantially the same components as those of the air cleaner case 1A according to Example 1, and a detailed description thereof will be omitted.

### (1) Configuration of Air Cleaner Case

In the air cleaner case 1B according to the present Example, as shown in FIG. 5, an annular gasket 22 formed of an elastic material such as rubber is attached to a through hole 21 formed in a bottom wall 5a. The inner circumferential side of this annular gasket 22 constitutes a dust discharge port 7. In addition, the annular gasket 22 is formed in a substantially C-shaped longitudinal section so as to be able to hold the bottom wall 5a from above and below. Further, a flange piece 23 with which a float member 12 can come into contact protrudes toward the inner circumferential side of the annular gasket 22. Further, on the bottom surface side of the annular gasket 22, a tapered surface 24 whose diameter reduces upward toward the opening of the dust discharge port 7 is formed. The case 1B is provided with a valve structure 11B which is disposed on the bottom side of the bottom wall 5a and opens and closes the dust discharge port 7. The valve structure 11B includes the float member 12, a guide member 13, and a valve body 14.

### (2) Action and Effect of Air Cleaner Case

Next, the action and effect of the air cleaner case 1B having the above configuration will be described. As shown in FIG. 5A, at a normal time, the float member 12 is held, by the guide member 13, in a state of being spaced apart downward from the annular gasket 22 by gravity. In this state, since the float member 12 is spaced apart from the annular gasket 22 to open the dust discharge port 7, dust d such as sand collected in the case 1B is discharged. On the other hand, as shown in FIG. 5B, at the time of water immersion, the float member 12 ascending due to its buoyancy together with the water level is guided toward the annular gasket 22 by the guide member 13. At this time, the float member 12 comes into contact with the bottom surface side of the annular gasket 22 to close the dust discharge port 7, whereby the water entry into the case 1B is suppressed.

The air cleaner case 1B of the present Example exerts the same action and effect as those of the above air cleaner case 1A, and the outer circumferential side (that is, the annular gasket 22) of the dust discharge port 7 of the bottom wall 5a and the float member 12 are formed of an elastic material. So, the sealability of the dust discharge port 7 by the float member 12 is enhanced.

### Example 3

Next, an air cleaner case 1C according to Example 3 will be described. The same reference numerals are given to substantially the same components as those of the air cleaner case 1A according to Example 1, and a detailed description thereof will be omitted.

### (1) Configuration of Air Cleaner Case

In the air cleaner case 1C according to the present Example, as shown in FIG. 6, a support hole 31 is formed in the center part of a bottom wall 5a, and, on the outer circumferential part of the support hole 31 of the bottom wall 5a, a plurality of dust discharge ports 7 are formed along the circumferential direction. The case 1C is provided with a valve structure 11C that is disposed on the bottom side of the bottom wall 5a and opens and closes the dust discharge port 7.

The valve structure 11C includes a float member 12, a guide member 37, and a valve body 32. The valve body 32 is attached to an upper part of the float member 12. The valve body 32 is spaced apart downward from the dust discharge port 7 together with the float member 12 to open the dust discharge port 7, and comes into contact with the outer circumferential side of the dust discharge port 7 of the bottom wall 5a (specifically, the outer circumferential part of the dust discharge port 7 on the bottom surface side of the bottom wall 5a), upon ascent of the float member 12, to close the dust discharge port 7. Specifically, the valve body 32 is formed of an elastic material such as rubber, and includes: a shaft part 33 which is vertically movably supported by the support hole 31 of the bottom wall 5a; and an umbrella-shaped part 34 which is connected to the lower end side of the shaft part 33 and whose outer circumferential part comes into contact with the outer circumferential side of the dust discharge port 7 of the bottom wall 5a to cover and close the plurality of dust discharge ports 7. An enlarged diameter part 35 for preventing the shaft part 33 from falling off from the support hole 31 is provided on the upper end side of the shaft part 33. Further, on the bottom surface side of the umbrella-shaped part 34, the float member 12 is integrally provided by adhesion, welding, or the like.

The guide part 37 holds the float member 12 in a state of being spaced downward from the dust discharge port 7 and, at the time of water immersion, guides the float member 12 ascending due to its buoyancy together with the water level toward the dust discharge port 7. Specifically, the reduced diameter part 34 of the valve body 32 is engaged with the upper surface of the bottom wall 5a so that the float member 12 is held in a state of being spaced apart downward from the dust discharge port 7, while the shaft part 33 of the valve body 32 is supported by the support hole 31 so that the float member 12 is guided toward the dust discharge port 7. Therefore, in the present Example, the guide part 37 is composed of the shaft part 33 of the valve body 32, the reduced diameter part 34, and the support hole 31 of the bottom wall 5a. The bottom wall 5a is provided with a tubular outer circumferential wall 38 that extends downward and surrounds the float member 12 and the valve body 32.

### (2) Action and Effect of Air Cleaner Case

Next, the action of the air cleaner case 1C having the above configuration will be described. As shown in FIG. 6A, at a normal time, the float member 12 is held, by the guide member 37, in a state of being spaced apart downward from the dust discharge port 7 by gravity. In this state, the valve body 32 integrated with the float member 12 is positioned at a descending end and is spaced apart from the dust discharge port 7 to open the dust discharge port 7, so that dust d such as sand collected in the case 1C is discharged. On the other hand, as shown in FIG. 6B, at the time of water immersion, the float member 12 ascending together with the water level due to its buoyancy is guided by the guide member 37 toward the dust discharge port 7. At this time, the outer circumferential part of the umbrella-shaped part 33 of the valve body 32 integral with the float member 12 comes into contact with the outer circumferential side of the dust discharge port 7 of the bottom wall 5a to cover and close the plurality of dust discharge ports 7, so that the water entry into the case 1C is suppressed.

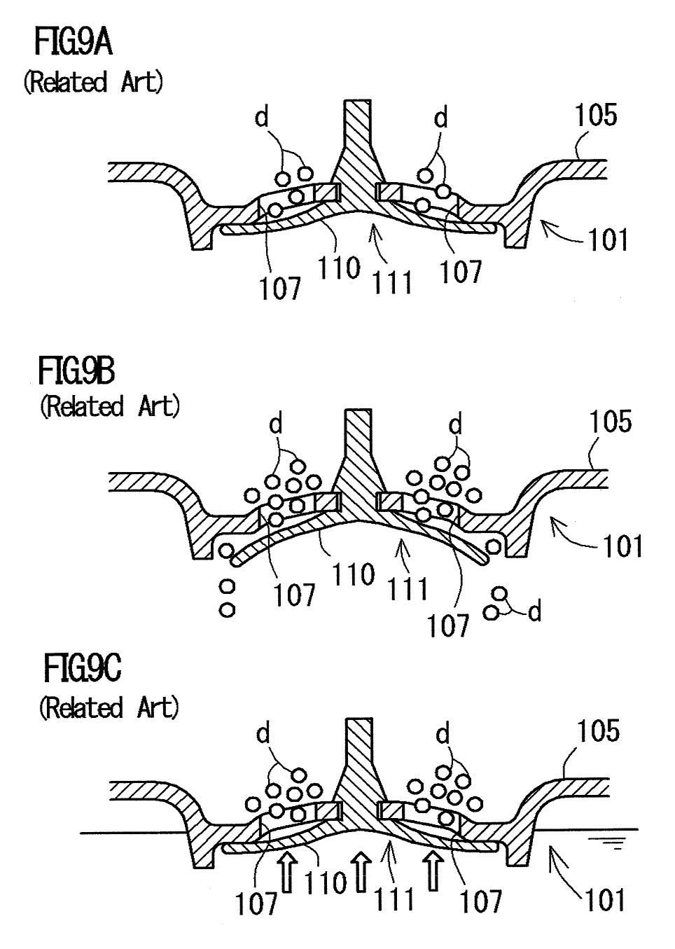

The air cleaner case 1C of the present Example exerts substantially the same action and effect as those of the air cleaner case 1A described above. Additionally, since the valve body 32 is attached to the upper part of the float member 12, the dust discharge port 7 is widely opened by the descent of the valve body 32, as compared with conventional cases in which the elastic valve 110 is provided so as not to be movable up and down (see FIG. 9). Therefore, the dust discharge port 7 is hardly clogged even with muddy dust d.

### Example 4

Next, an air cleaner case 1D according to Example 4 will be described. The same reference numerals are given to substantially the same components as those of the air cleaner case 1A according to Example 1, and a detailed description thereof will be omitted.

### (1) Configuration of Air Cleaner Case

In the air cleaner case 1D according to the present Example, as shown in FIG. 7, a support hole 41 is formed in the center part of a bottom wall 5a, and, on the outer circumferential part of the support hole 41 of the bottom wall 5a, a plurality of dust discharge ports 7 are formed along the circumferential direction. The case 1D is provided with a valve structure 11D that is disposed on the bottom side of the bottom wall 5a and opens and closes the dust discharge port 7.

The valve structure 1 ID includes a float member 12, a guide member 13, and a valve body 42. The valve body 42 is provided so that it can ascend and descend between the float member 12 and the bottom wall 5a and can be pushed up by the float member 12 ascending at the time of water immersion. The valve body 42 is spaced apart downward from the dust discharge port 7 together with the float member 12 to open the dust discharge port 7 and, upon ascent of the float member 12, is pushed up and comes into contact with the outer circumferential side of the dust discharge port 7 of the bottom wall 5a (specifically, the outer circumferential part of the dust discharge port 7 on the bottom surface side of the bottom wall 5a) to close the dust discharge port 7. Specifically, the valve body 42 is formed of an elastic material such as rubber, and includes: a shaft part 43 supported by a support hole 41 of the bottom wall 5a so as to be movable up and down; and an umbrella-shaped part 44 which is connected to the lower end side of the shaft part 43 and whose outer circumferential part comes into contact with the outer circumferential side of the dust discharge port 7 of the bottom wall 5a to cover and close the plurality of dust discharge ports 7. An enlarged diameter part 45 for preventing the shaft part 43 from falling off from the support hole 41 is provided on the upper end side of the shaft part 43. On the bottom surface side of the umbrella-shaped part 44, a pushed-up part 46 that can be pushed up by the float member 12 ascending at the time of water immersion is formed. The pushed-up part 46 is formed in a concave shape along the surface of the float member 12. The guide wall 16 constituting the guide part 13 has an inner diameter slightly larger than the outer diameter of the umbrella-shaped part 44 of the valve body 42.

### (2) Action and Effect of Air Cleaner Case

Next, the action of the air cleaner case 1D having the above configuration will be described. As shown in FIG. 7A, at a normal time, the float member 12 is held, by the guide member 13, in a state of being spaced apart downward from the dust discharge port 7 by gravity. In this state, since the valve body 42 is positioned at a descending end and is spaced apart from the dust discharge port 7 to open the dust discharge port 7, the dust d such as sand collected in the case 1D is discharged. On the other hand, as shown in FIG. 7B, at the time of water immersion, the float member 12 ascending due to its buoyancy together with the water level is guided toward the dust discharge port 7 by the guide member 13. At this time, the pushed-up part 46 of the umbrella-shaped part 44 is pushed up by the ascending float member 12 so that the outer circumferential part of the umbrella-shaped part 44 comes into contact with the outer circumferential side of the dust discharge port 7 of the bottom wall 5a to cover and close the plurality of dust discharge ports 7 so that the water entry into the case 1D is suppressed.

The air cleaner case 1D of the present Example exerts substantially the same action and effect as those of the air cleaner case 1A described above. Additionally, since the valve body 42 is provided so that it can ascend and descend between the float member 12 and the bottom wall 5a and can be pushed up by the float member 12 ascending at the time of water immersion, the dust discharge port 7 is widely opened by the descent of the valve element 42 as compared with conventional cases in which the elastic valve 110 is provided so as not to be movable up and down (see FIG. 9). Therefore, the dust discharge port 7 is hardly clogged even with muddy dust d.

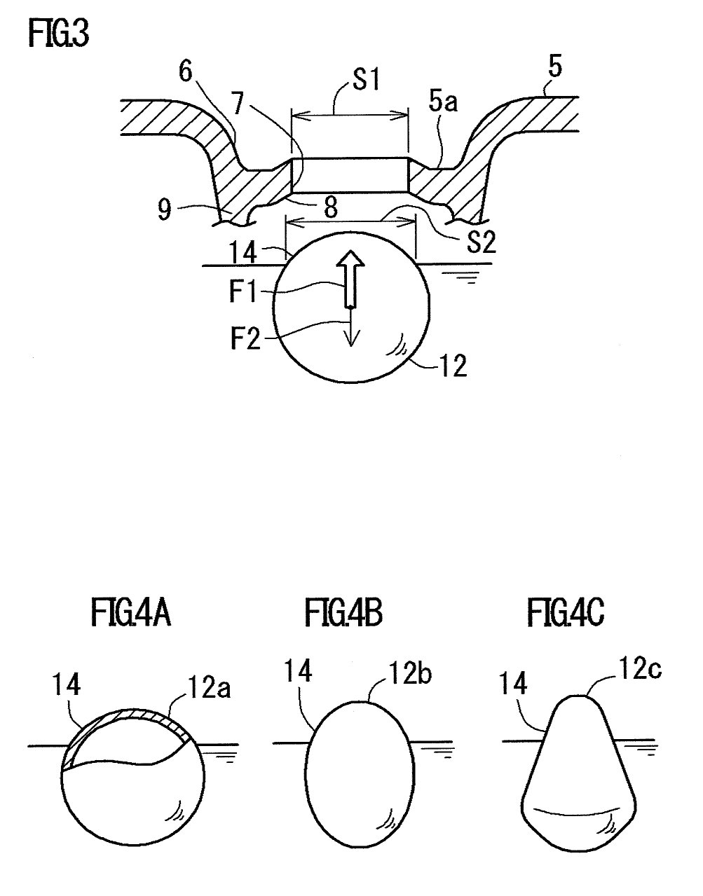

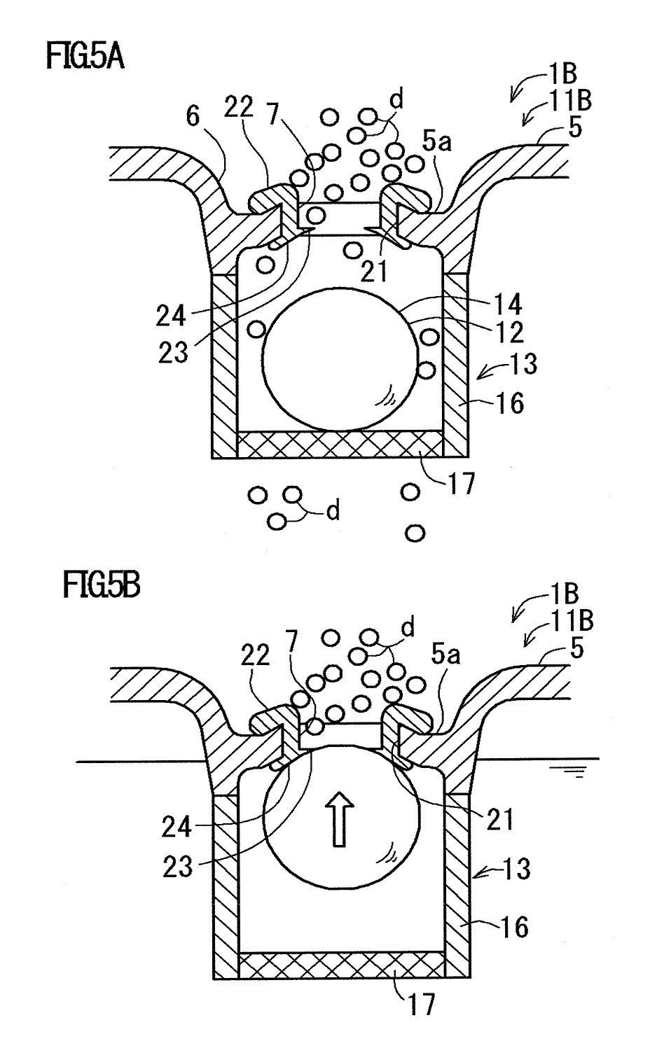

The present invention is not limited to the above-described Examples, and can be variously modified within the scope of the present invention depending on the purpose and use. The solid float member 12 has been exemplified in the above Examples, but the present invention is not limited thereto. For example, a hollow (i.e., shell-shape) float member 12a (see FIG. 4A) may be adopted. Further, for example, an ellipsoidal float member 12b (see FIG. 4B) or a conical float member 12c (see FIG. 4C) may be adopted.

The surface of the float member 12 ascending at the time of water immersion is configured to come into contact with the outer circumferential side of the dust discharge port 7 of the bottom wall 5a to close the dust discharge port 7 in the above Examples, but the present invention is not limited thereto. For example, as shown in FIG. 8, a valve body 54 made of an elastic material such as rubber may be provided on an upper part of the float member 12 so that the valve body 54 of the float member 12 ascending at the time of water immersion comes into contact with the outer circumferential side of the dust discharge port 7 of the bottom wall 5a so as to close the dust discharge port 7.

Only the holding part 17, of the guide wall 16 and the holding part 17 which constitute the guide member 13, is formed so as to allow passage of the dust d in the above Examples, but the present invention is not limited thereto. For example, both the guide wall 16 and the holding part 17 may be formed so as to allow passage of the dust d.

The guide wall 16 retrofitted to the bottom wall 5a of the cases 1A to ID has been exemplified in the above Examples, but the present invention is not limited thereto. For example, the guide wall 16 may be formed integrally with the bottom wall 5a of the cases 1A to ID.

The dust discharge port 7 formed in the bottom wall 5a of the concave part 6 of the bottom wall 5 of the cases 1A to 1D has been exemplified in the above Examples, but the present invention is not limited thereto. For example, the dust discharge port 7 may be formed in the flat bottom wall 5 of the cases 1A to 1D.

Further, the air cleaner cases 1A to 1D used in an internal combustion engine have been exemplified in the above Examples, but the present invention is not limited thereto. For example, the air cleaner cases 1A to 1D may be used in an air conditioner, an air cleaner, or the like.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above-described embodiments, and various variations and modifications may be possible without departing from the scope of the present invention.

The present invention is widely used as a technology relating to an air cleaner that removes dust such as sand, mote, and dirt contained in inhaled air.

What is claimed is:

1. An air cleaner case having a dust discharge port provided in a bottom wall of the air cleaner case,
the air cleaner case comprising a valve structure capable of opening and closing the dust discharge port,
wherein the valve structure comprises:
a float member which is disposed below the dust discharge port and can float on water due to buoyancy;
a guide member which holds the float member in a state of being spaced downward from the dust discharge port and, at the time of water immersion, guides the float member ascending due to buoyancy together with the water level toward the dust discharge port; and
a valve body which is spaced downward from the dust discharge port together with the float member to open the dust discharge port and, upon ascent of the float member, comes into contact with an outer circumferential side of the dust discharge port of the bottom wall to close the dust discharge port.

2. The air cleaner case according to claim 1, wherein the valve body is composed of the float member capable of coming into contact with the outer circumferential side of the dust discharge port of the bottom wall.

3. The air cleaner case according to claim 2, wherein an opening area of the dust discharge port is smaller than an area surrounded by a line of contact with the water surface of the float member floating on water.

4. The air cleaner case according to claim 2, wherein the opening of the dust discharge port is formed in a planar circular shape, and wherein the float member is formed in a spherical shape.

5. The air cleaner case according to claim 2, wherein at least one of the outer circumferential side of the dust discharge port of the bottom wall and the float member is formed of an elastic material.

6. The air cleaner case according to claim 2, wherein the float member is formed of an elastic material and formed in a solid or hollow spherical shape.

7. The air cleaner case according to claim 2, wherein an annular gasket is attached to a through hole formed in the bottom wall, the annular gasket being formed of an elastic material and having an inner circumferential side which constitutes the dust discharge port, and
wherein the float member comes into contact with the annular gasket to close the dust discharge port.

8. The air cleaner case according to claim 2, wherein a tapered surface whose diameter reduces upward toward the opening of the dust discharge port is formed on the outer circumferential side of the dust discharge port of the bottom wall.

9. The air cleaner case according to claim 1, wherein the guide member comprises a tubular guide wall extending downward from the bottom wall so as to surround the float member and a holding part provided on the bottom side of the guide wall, and wherein the holding part is formed so as to permit passage of dust and to allow the float member to be mounted and held.

10. The air cleaner case according to claim 1, wherein the valve body is attached to an upper part of the float member.

11. The air cleaner case according to claim 1, wherein the valve body is provided to be capable of ascending and descending between the float member and the bottom wall and capable of being pushed up by the float member ascending at the time of water immersion.
